(19) United States
(12) Patent Application Publication
(10) Pub. No.: US 2025/0128592 A1
(43) Pub. Date: Apr. 24, 2025

(54) COOLING PACKAGE LAYOUT

(71) Applicant: Deere & Company, Moline, IL (US)

(72) Inventors: Matthew Jeske, Dubuque, IA (US); Mark Ritter, East Dubuque, IL (US); Mohd Kashif Salman, Pune (IN)

(21) Appl. No.: 18/493,280

(22) Filed: Oct. 24, 2023

(51) Int. Cl. B60K 11/04

(52) U.S. Cl. CPC B60K 11/04

(57) ABSTRACT

A cooling system to cool a power source of a work machine. The cooling system comprises a fan, a plenum, a first heat exchanger and a second heat exchanger. The heat exchangers are placed within the plenum. A plane defined normal to the fan surface and along the length of the vehicle. The first heat exchanger and the second heat exchanger are placed either side of the plane and form an acute angle with the plane.

### CROSS-REFERENCE TO RELATED APPLICATIONS

### Background

Construction machinery such as Skid steers and Compact tracked loaders continue to grow in both horsepower and hydraulic power, while the frame size is often required to be unchanged or have limited growth. With increasing horsepower and high flow to be competitive in the small frame size class, the need to limit frame changes and keep cost low for the customer is a primary goal.

Today most Skid steers and Compact tracked loaders utilize a standard direct drive fan with inline or stacked coolers or a cooling package on top of the engine with a hydraulically driven fan.

### SUMMARY

An objective of the invention is to provide a cooling system to cool a power source of a work machine. The system comprising a fan, a plenum, a first heat exchanger and a second heat exchanger placed within the plenum. The first heat exchanger and the second heat exchanger are placed to form an acute angle with each other. The first heat exchanger and the second heat exchanger are spaced apart forming a gap in between and the gap is symmetrical on either side of the plane.

A further objective of the invention is to provide a blocking member is placed in the gap between the first and second heat exchangers.

A further objective of the invention is to provide a work machine which comprises a traveling body having a ground-engaging mechanism, a power source, a cooling system to cool the power source, the cooling system including a fan and a plenum. A first heat exchanger and a second heat exchanger placed within the plenum. The first heat exchanger and the second heat exchanger form an acute angle with the plane.

Other features and aspects of the disclosure will become apparent by consideration of the following detailed description and accompanying drawings.

### BRIEF DESCRIPTION OF THE DRAWINGS

FIG. 1 shows a work machine along with the inventive coolant system;

FIG. 2 shows a prime mover along with inventive coolant system;

FIG. 3 shows arrangement of heat exchangers and fan;

FIG. 4 illustrates the layout of the coolant system;

FIG. 5 shows arrangement of heat exchangers;

FIG. 6 shows the cross-sectional view of the plenum and heat exchangers; and

FIG. 7 shows plenum in perspective view.

Before any embodiments are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting.

### DETAILED DESCRIPTION

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

As used herein, the term “controller” is a computing device including a processor and a memory. The “controller” may be a single device or alternatively multiple devices. The controller may further refer to any hardware, software, firmware, electronic control component, processing logic, processing device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

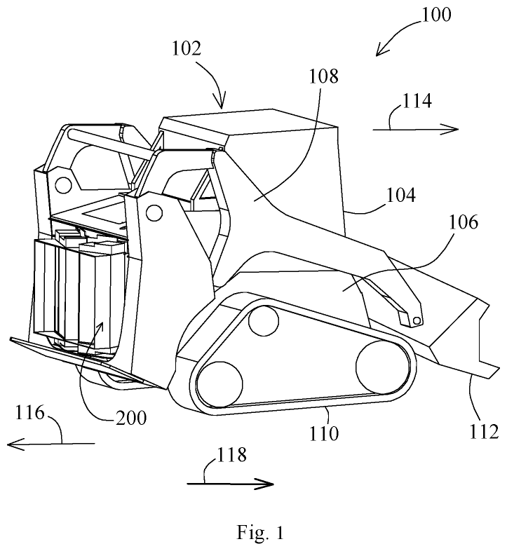

FIG. 1 shows an exemplary embodiment of a work machine 100. The work machine 100 is embodied as a Skid steer including a body 102 and a boom structure 108 to carry a bucket 112 or an implement. The moveable boom structure 108 can be pivotally mounted on the traveling body 102 by means of a swing pivot, enabling the moveable boom structure 108 to rotate in a yaw direction. The traveling body 102 includes a ground-engaging mechanism 110, including but not limited to, tracks and wheels. The ground-engaging mechanism 110 shown include a pair of ground engaging tracks on opposite sides of the traveling body 102 for moving along a ground surface. The moveable structure includes an operator cab 104.

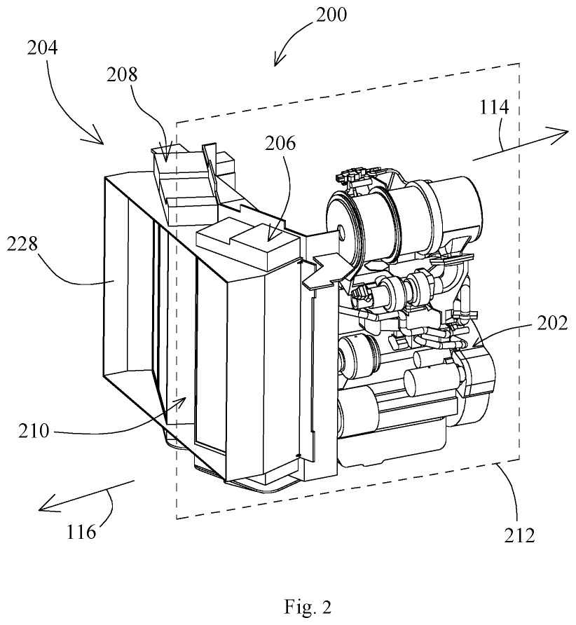

FIG. 2 shows the prime mover 200 for the work machine 100. The illustrated prime mover 200 includes an engine 202 and a cooling system 204 to cool the engine 202. The cooling system 204 may comprise a fan 216, a plenum 228 and heat exchangers 205. Hot fluids including the engine coolant, hydraulic oil, transmission oil, etc., are routed through the heat exchangers 205 to cool and maintain appropriate temperatures. Other configurations of the components of the cooling system 204 are possible and are considered within the scope of the disclosure. In a preferred embodiment, the fan 216 is directly driven by the engine 202. Disposed between fan 216 and heat exchangers 205 is the plenum 228. The plenum 228 defines the space between fan 216 and heat exchangers 205 and provides an optimally sized and spaced transition duct that, together with a fan shroud 218. The fan 216 forces ambient air into the plenum 228 cooling compartment via the heat exchangers 205 and cools the fluids within the heat exchangers 205. In a preferred embodiment, the fan 216 may be a direct drive mechanical fan. It is possible that fan is driven by a hydraulic or electrical motor independent from engine. The later form allows to control the fan 216 speed as per need. The heat exchangers 205 may include multiple heat exchangers 206, 208 forming a fully or partially enclosed heat exchanger package within the plenum 228 cooling compartment. The plenum 228 is generally rectangular in shape and corresponds to the radiators arrangement 205 and the plenum 228 may include multiple pockets to accommodate the radiators 205.

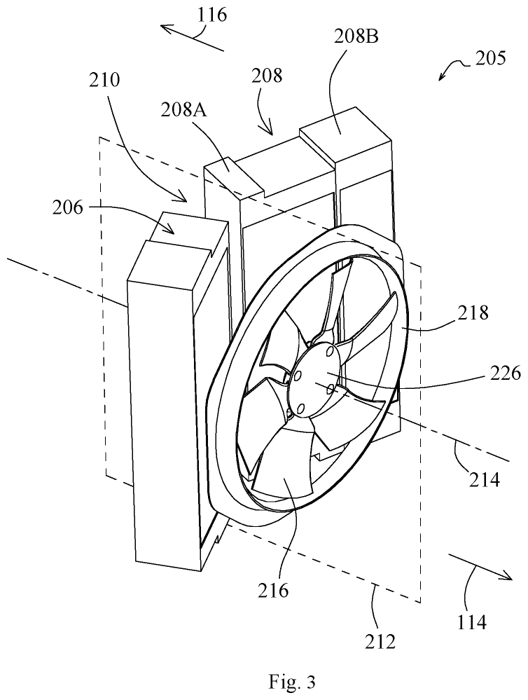

Referring now to FIG. 3, cooling system 204 is shown in perspective view without the plenum 228. As shown, fan shroud 218 is circular in shape corresponding to fan 216 and is concentric about fan's axis 214. The fan 216 may have a central hub 226 which is coupled to the engine 202. In a preferred embodiment, a plane 212 is defined such that the plane 212 may pass through the center of fan 216 and normal to the fan's surface 217. The fan's surface may be defined as a plane in which the fan blades rotate and the fan's surface 217 is normal to the fan's axis 214.

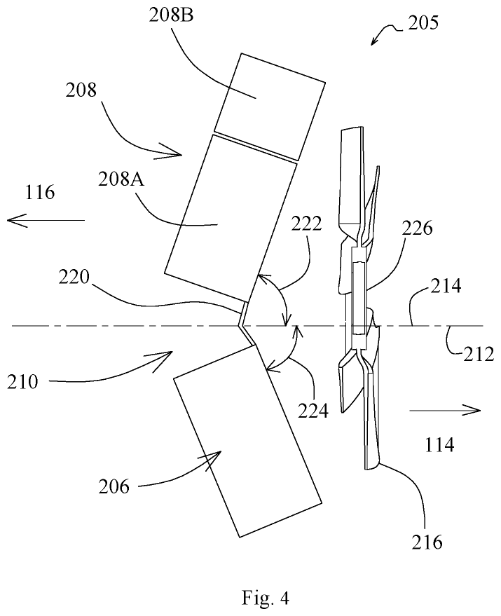

As shown in FIG. 4, a pair of heat exchangers 205 are placed away from the fan 216 in the direction of air flow and within the plenum 228. As shown in the layout, a first heat exchanger 206 is placed on first side of the plane 212 and a second heat exchanger 208 is placed on a second side of the plane 212. Both heat exchangers 205 are placed at an equidistance from the plane 212 and thus form a gap 210 between them. The heat exchangers 205 are placed in such a way that when viewed from top, the first heat exchanger 206 makes a first acute angle 224 with the plane 212 and the second heat exchanger 208 makes a second acute angle 222 with the plane 212. Thus, the heat exchangers 212 make an angle less than 180 with each other and form a v shape. In a preferred embodiment, both heat exchangers 205 make equal acute angle on either side of the plane.

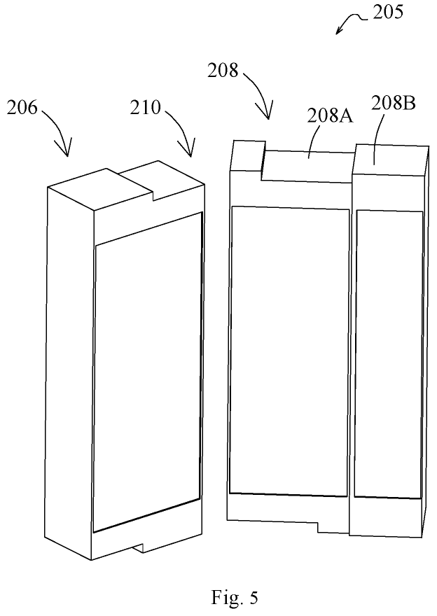

As shown in FIG. 5, in a preferred embodiment, the first heat exchanger 206 may be formed as a single heat exchanger 206A and the second heat exchanger 208 is formed of a group of two separate heat exchangers 208A & 208B placed in same plane and side by side arrangement. It is possible that the second group of exchangers 208 may be placed side by side or stacked one above other. In an exemplary embodiment, first heat exchanger 206 may comprise of a first group of heat exchangers. The first group of heat exchangers may be arranged in a single plane either placed side by side or stacked one above other. However, it is contemplated that multiple variations and combinations of the first and second heat exchanger arrangement is possible. This arrangement helps in cooling multiple fluids.

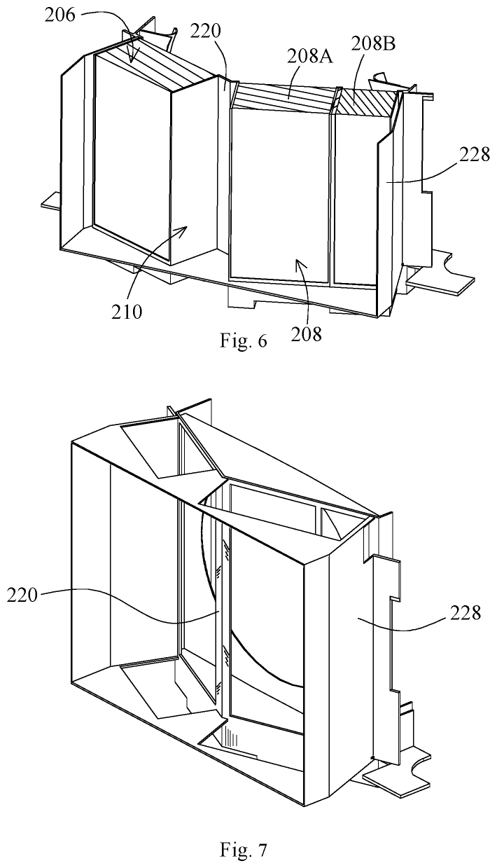

As shown in FIG. 4 and FIG. 6, a blocking member 220 is placed between the first heat exchanger 206 and the second heat exchanger 208 such that the blocking member 220 bridges the gap 210 between the heat exchangers 205. The blocking member 220 blocks the air passing from fan side to outside. In a preferred embodiment, the blocking member 220 is made out of sheet metal and is integral to the plenum 228 as shown in FIG. 7. This configuration allows for a much more universal flow of air through the heat exchangers 205. Better airflow means better performance and capacity for a given size of machine without the need for machine size changes/layout and without the use of an additional hydraulic motor to run the fan 216. As the fan 216 induces air flow across through the heat exchangers 205, the air flow would turn over 180° to re-enter the heat exchangers 205 at the center 210 region. The blocking member 220 which bridges the gap 210 between the heat exchangers 205 will block the reentry of air flow and forces the air towards the outward direction of the machine.

In preferred embodiment of the cooling system 204, the fan 216 is arranged such that the fan 216 rotates in the plane which is normal to the length of the vehicle direction 118. It is possible that the cooling system 204 is arranged at the forward direction 114 of the vehicle or at the rear direction 116 of the vehicle. If the cooling system 204 is arranged at forward end, the heat exchangers are placed ahead of the fan in the vehicle forward direction 114. If the cooling system 204 is placed at rear end of the vehicle, the heat exchangers are placed at backward direction 116 of the fan 216 considering the length of vehicle 118. It is contemplated that according to the machine form, many other variations with respect to the cooling system 204 placement are possible. In a further exemplary embodiment, the fan 216 is placed at an angle with respect to the length direction 118 of the vehicle and in this arrangement, the fan 216 rotates in a plane which is not normal to the vehicle length direction 118.

As shown in FIG. 4 and FIG. 6, a blocking member 220 is placed between the first heat exchanger 206 and the second heat exchanger 208 such that the blocking member 220 bridges the gap 210 between the heat exchangers 205. The blocking member 220 blocks the air passing from fan side to outside. In a preferred embodiment, the blocking member 220 is made out of sheet metal and is integral to the plenum 228 as shown in FIG. 7. This configuration allows for a much more universal flow of air through the heat exchangers 205. Better airflow means better performance and capacity for a given size of machine without the need for machine size changes/layout and without the use of an additional hydraulic motor to run the fan 216. As the fan 216 induces air flow across through the heat exchangers 205, the air flow would turn over 180° to re-enter the heat exchangers 205 at the center 210 region. The blocking member 220 which bridges the gap 210 between the heat exchangers 205 will block the reentry of air flow and forces the air towards the outward direction of the machine.

In preferred embodiment of the cooling system 204, the fan 216 is arranged such that the fan 216 rotates in the plane which is normal to the length of the vehicle direction 118. It is possible that the cooling system 204 is arranged at the forward direction 114 of the vehicle or at the rear direction 116 of the vehicle. If the cooling system 204 is arranged at forward end, the heat exchangers are placed ahead of the fan in the vehicle forward direction 114. If the cooling system 204 is placed at rear end of the vehicle, the heat exchangers are placed at backward direction 116 of the fan 216 considering the length of vehicle 118. It is contemplated that according to the machine form, many other variations with respect to the cooling system 204 placement are possible. In a further exemplary embodiment, the fan 216 is placed at an angle with respect to the length direction 118 of the vehicle and in this arrangement, the fan 216 rotates in a plane which is not normal to the vehicle length direction 118.

What is claimed is:

1. A cooling system to cool a power source of a work machine comprising:
a fan and a plenum;
a first heat exchanger and a second heat exchanger placed within the plenum;
a plane normal to fan's surface and passing through the plenum; wherein
the first heat exchanger and the second heat exchanger are placed on either side of the plane and form an acute angle with the plane.

2. The cooling system according to claim 1, wherein the first heat exchanger cools a first fluid and the second heat exchanger cools a second fluid.

3. The cooling system according to claim 1, wherein the first heat exchanger comprises a first group of heat exchangers.

4. The cooling system according to claim 1, wherein the second heat exchanger comprises a second group of exchangers.

5. The cooling system according to claim 1, wherein the first heat exchanger and the second heat exchanger are spaced apart forming a gap in between and the gap is symmetrical on either side of the plane.

6. The cooling system according to claim 5, wherein a blocking member is placed in the gap.

7. The cooling system according to claim 6, wherein the blocking member is integral to plenum.

8. The cooling system according to the claim 1, wherein the plane is parallel to length of work machine.

9. The cooling system according to claim 1, wherein the first heat exchanger and the second heat exchanger forms equal angle with the plane.

10. A work machine comprising:
a traveling body having a ground-engaging mechanism;
a power source;
a cooling system to cool the power source;
the cooling system including a fan and a plenum;
a first heat exchanger and a second heat exchanger placed within the plenum;
a plane normal to fan surface and passing through the plenum; wherein
the first heat exchanger and the second heat exchanger are placed on either side of the plane and form an acute angle with the plane.

11. The work machine according to claim 10, wherein the first heat exchanger cools a first fluid and the second heat exchanger cools a second fluid.

12. The work machine according to claim 10, wherein the first heat exchanger comprises a first group of heat exchangers.

13. The work machine according to claim 10, wherein the second heat exchanger comprises a second group of exchangers.

14. The work machine according to claim 10, wherein the first heat exchanger and the second heat exchanger are spaced apart forming a gap in between and the gap is symmetrical on either side of the plane.

15. The work machine according to claim 10, wherein a blocking member is placed in the gap.

16. The work machine according to claim 15, wherein the blocking member is integral to plenum.

17. The work machine according to the claim 10, wherein the plane is parallel to length of work machine

18. The work machine according to claim 10, wherein the first heat exchanger and the second heat exchanger forms equal angle with the plane.
